(19) United States
(12) Patent Application Publication
(10) Pub. No.: US 2026/0010461 A1
(43) Pub. Date: Jan. 8, 2026

(54) METHOD AND APPARATUS WITH SOFTWARE DEBUGGING BENCHMARK SYSTEM

(71) Applicants: Samsung Electronics Co., Ltd., Suwon-si (KR); Korea Advanced Institute of Science and Technology, Daejeon (KR)

(72) Inventors: Do-Ha HWANG, Suwon-si (KR); Sung Min KANG, Daejeon (KR); Jae Yong LEE, Daejeon (KR); Shin YOO, Daejeon (KR)

(73) Assignees: Samsung Electronics Co., Ltd., Suwon-si (KR); Korea Advanced Institute of Science and Technology, Daejeon (KR)

(21) Appl. No.: 19/206,686

(22) Filed: May 13, 2025

(30) Foreign Application Priority Data
Jul. 2, 2024 (KR) 10-2024-0087100

(51) Int. Cl. G06F 11/362; G06F 8/71; G06F 11/34

(52) U.S. Cl. CPC G06F 11/362; G06F 8/71; G06F 11/3428

(57) ABSTRACT

An operating method of a software debugging benchmark system includes: monitoring pull requests (PRs) created in a project and identifying, in a PR identified by the monitoring, a commit that adds a source code change and test code; determining whether the commit is a potential failure benchmark component by applying predetermined criteria to the commit; based on determining that the commit is a potential failure benchmark component, verifying, in a virtual environment, whether the commit has fixed an actual failure; and based on the verifying, storing a failure PR corresponding to the commit in a database as a failure detection test and failure fix commit.

### CROSS-REFERENCE TO RELATED APPLICATIONS

This application claims the benefit under 35 USC § 119 (a) of Korean Patent Application No. 10-2024-0087100, filed on Jul. 2, 2024, in the Korean Intellectual Property Office, the entire disclosure of which is incorporated herein by reference for all purposes.

### BACKGROUND

### 1. Field

The following description relates to a method and apparatus with a software debugging benchmark system.

### 2. Description of Related Art

Recently, the importance of a benchmark has been increasing as it is important to evaluate different technologies (e.g., different software technologies) using the same target for a fair evaluation of such different technologies. When data that is simply an input to an algorithm, such as compiler optimization, is a benchmarking target, a standard benchmark may be established and managed by experts, which allows for fair comparisons between targets of the standard benchmark. However, a benchmark that evaluates a software engineering tool whose purpose is to increase actual software development efficiency needs to be realistic and may thus be difficult to collect and maintain. In particular, in the case of automatic debugging technology that aims to automatically identify a location of a failure or automatically fix a failure, more effort may be required to collect data for benchmarking since the data to be collected are of software failures, which correspond to an abnormal state.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an operating method of a software debugging benchmark system includes: monitoring pull requests (PRs) created in a project and identifying, in a PR identified by the monitoring, a commit that adds a source code change and test code; determining whether the commit is a potential failure benchmark component by applying predetermined criteria to the commit; based on determining that the commit is a potential failure benchmark component, verifying, in a virtual environment, whether the commit has fixed an actual failure; and based on the verifying, storing a failure PR corresponding to the commit in a database as a failure detection test and failure fix commit.

The method may further include: receiving a user input through a user interface and providing information related to a failure corresponding to the user input using failure data stored in the database.

The predetermined criteria may include: a first criterion for determining whether the actual failure exists in source code, a second criterion for determining whether the actual failure is reproducible, and/or a third criterion for determining whether the actual failure is independent.

The verifying of whether the commit has fixed the actual failure may include: determining whether, in the virtual environment, a test performed on the project in a state before applying the commit fails and whether the a test performed on the project after applying the commit succeeds.

The database may include: metadata on tests on the pre-commit project and the post-commit project, bug-revealing test data used for the tests, and/or patch information data.

The user interface may include: a command-line interface (CLI)-based frontend that receives an information inquiry command, a failure inquiry command, a compile command, or a test execution command from a user input device and provides functions corresponding to the information inquiry command, the failure inquiry command, a compile command, or the test execution command.

The CLI-based frontend may be configured to provide a function corresponding to an auto-update execution command that allows the user to update a failure benchmark.

The virtual environment may include a Docker container or a virtual machine.

The storing of the failure PR in the database may include: classifying and storing a failure type according to a type of the failure PR that has been fixed by the commit.

A non-transitory computer-readable storage medium may store instructions that, when executed by a processor, cause the processor to perform any of the methods.

In another general aspect, an electronic device includes: a memory configured to store instructions; and one or more processors, wherein the instructions, when executed by the one or more processors, cause the electronic device to: monitor pull requests (PRs) created in a project and identify, in a PR identified by the monitoring, a commit that adds a source code change and test code; determine whether the commit is a potential failure benchmark component by applying predetermined criteria to the criteria; based on determining that the commit is a potential failure benchmark component, verify, in a virtual environment, whether the commit has fixed an actual failure; and based on the verifying, store a failure PR corresponding to the commit in a database as a failure detection test and failure fix commit.

The instructions, when executed by the one or more processors, may cause the electronic device to: receive a user input through a user interface and provide information related to a failure corresponding to the user input using failure data stored in the database.

The predetermined criteria may include: a first criterion for determining whether an actual failure exists in source code, a second criterion for determining whether the actual failure is reproducible, and/or a third criterion for determining whether the actual failure is independent.

The instructions, when executed by the one or more processors, may cause the electronic device to: determine whether, in the virtual environment, a test performed on the project in a state before applying the commit fails and whether a test performed on the project after applying the commit succeeds.

The database may include: metadata on the test on the pre-commit project and post-commit project, bug-revealing test data used for the tests, and/or patch information data.

The user interface may include: a command-line interface (CLI)-based frontend that receives at least one of an information inquiry command, a failure inquiry command, a compile command, or a test execution command from a user input device and provides functions corresponding to the information inquiry command, the failure inquiry command, a compile command, or the test execution command.

The CLI-based frontend may be configured to provide a function corresponding to an auto-update execution command that allows the user to update a failure benchmark.

The virtual environment may include a Docker container or a virtual machine.

The instructions, when executed by the one or more processors, may cause the electronic device to: classify and store a failure type according to a type of the failure PR that has been fixed by the commit.

In another general aspect, a method of collecting code commits includes: detecting commits of source code to a project; selecting, from among the detected commits, candidate commits that are determined to be suitable for failure benchmarking; for each of the candidate commits, performing a corresponding pre-commit test of the project and a corresponding post-commit test of the project; collecting those of the candidate commits whose pre-commit test produces a failure of the pre-commit project and whose corresponding post-commit test does not have the corresponding failure; and training a large language model based on the collected candidate commits.

Other features and aspects will be apparent from the following detailed description, the drawings, and the claims.

### BRIEF DESCRIPTION OF THE DRAWINGS

FIG. 1 illustrates an example of an operating method of a software debugging benchmark system, according to one or more embodiments.

FIG. 2 illustrates an example of a cloud backend of a benchmark system, according to one or more embodiments.

FIG. 3 illustrates an example of operation of a frontend of a benchmark system, according to one or more embodiments.

FIG. 4 illustrates an example of overall operation of a benchmark system, according to one or more embodiments.

FIG. 5 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Generally, a benchmark is a process or a standard for measuring something through a standardized (repeatable) test to evaluate performance, quality, or other software attributes. In software engineering, a benchmark is used primarily to comparatively evaluate how efficiently a system, an application, or a component performs a given task. A benchmark may measure speed, throughput, resource usage, and the like while performing a task. When a same benchmark tool or algorithm is used for testing different systems (or different versions of a system), benchmarking results allow the performance of the tested systems to be meaningfully compared to each other. Through this, software users such as developers and researchers can optimize system performance, identify improvements, and make objective comparisons between different solutions. In addition, a benchmark may be utilized as an important tool for evaluating an impact of a software update or an introduction of new technology.

A software debugging benchmark system (hereinafter, also referred to as a benchmark system) may be a standardized test and evaluation system for a software debugging program designed to efficiently discover and fix a software bug. A benchmark system may automatically collect, verify, and store records of, and associated data about, failures that occurs in various software projects, allowing performance and effectiveness in a software debugging process to be measured and compared. Through this, a user may evaluate effectiveness of a specific debugging tool or technique and may quickly identify and resolve a problem. A benchmark system may systematically manage failure data to improve a quality and reliability of a debugging process and to play an important role in software maintenance and improvement.

For improvement of a large language model (LLM), a benchmark system may be utilized in various ways. First, a benchmark system may be used to evaluate a code debugging capability of an LLM. A benchmark system may provide standardized failure data to allow an objective evaluation of how accurately an LLM identifies and fixes bugs. In addition, a benchmark system may also be used as data to train an LLM in learning various bug patterns and to suggest better debugging solutions based on the trained learning.

A benchmark system may also be used to evaluate the generalization ability of an LLM. A benchmark system may include various projects and failure cases to verify the generalization ability of an LLM and also to play an important role in evaluating and improving performance of an automatic debugging tool that utilizes an LLM. Users may objectively compare and improve the performance of LLM-based debugging tools.

However, data leakage issues may occur in a benchmark system in various ways and may significantly affect a performance evaluation and generalization ability of a model. A data leakage may occur when unnecessary information sharing occurs between training data and test data, which may cause a model to falsely show better performance than actual performance.

First, data leakage may occur due to redundancy between the training data and the test data. When training data for a benchmark is used in a process of training an LLM, the model may in effect store the data (its state may be a form of encoding of the training data). Subsequently, when some of the same benchmark data that was used for training is also used in evaluating/benchmarking the LLM, the LLM may show high performance based on the data the LLM already knows. This may distort the evaluation of the LLM, for example by measuring the generalization ability of the LLM as being greater that the actual generalization ability of the LLM.

In the description below, a software debugging benchmark system may may maintain consistent benchmarking performance without a data leakage during a training process of an LLM by preventing a data leakage and may automatically update benchmark data.

Examples and embodiments of the software debugging benchmark system are described below.

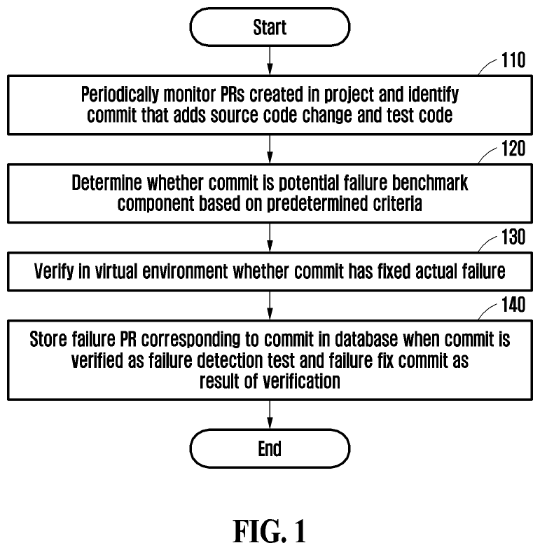

FIG. 1 illustrates an example of an operating method of the software debugging benchmark system, according to one or more embodiments.

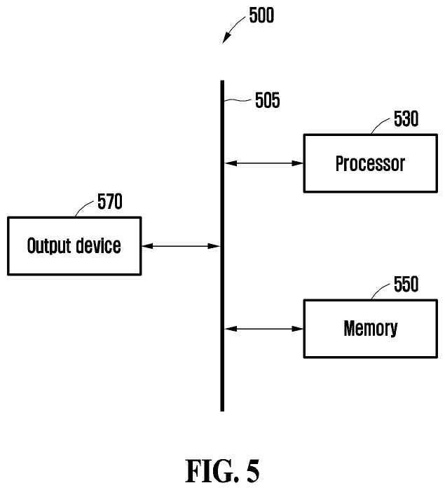

Operations 110 to 140 are described as being performed using an electronic device 500 shown in FIG. 5. However, operations 110 to 140 may also be performed by another suitable electronic device in a suitable system.

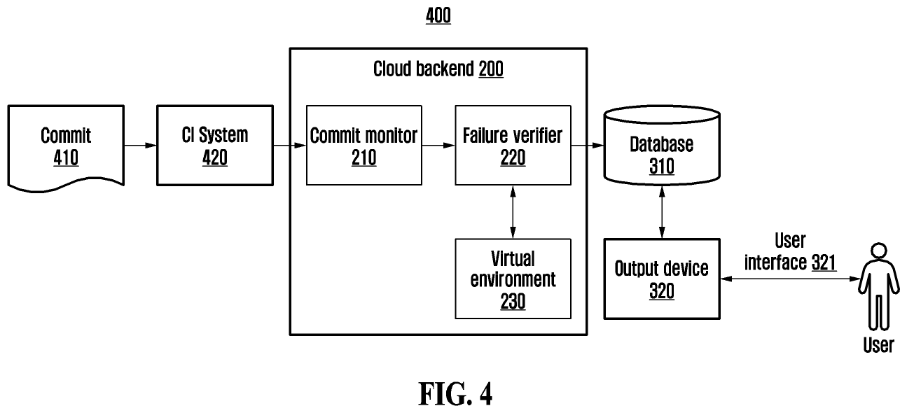

The electronic device 500 may drive a software debugging benchmark system (e.g., a software debugging benchmark system 400 of FIG. 4). The electronic device 500 may periodically update a database for driving the software debugging benchmark system. A method of updating the software debugging benchmark system (hereinafter, also referred to as the benchmark system) is described in detail below.

In the examples described below, a benchmark system may avoid the aforementioned data leakage problem that can occur when evaluating an automatic debugging technique (e.g., an LLM-based automatic debugging technique) by automatically collecting new failures. After a user selects, for example, an open-source project that is to be benchmarked and completes basic settings and configuration (for example, in a source code control system (SCCS) or a software development environment), the electronic device 500 may monitor newly added code changes to dynamically filter out (collect) failures that have been verified to be reproducible and automatically add those failures to the benchmark system. In addition to including a code change (or patch) corresponding to a failure, the electronic device 500 may also provide a tool to enhance the reliability of benchmarks such as builds and test execution.

In operation 110, the electronic device 500 may periodically monitor pull requests (PRs) created in a project (e.g., using an SCCS) and identify commits (e.g., a commit 410 of FIG. 4) that add source code changes and test code.

In software development environments, SCCSs, or the like, a PR (or “checkout”) is a transaction for extracting and locking/protecting a code change (modification or addition) crafted by a developer, into a project. In some implementations, A PR may prevent others from updating the part of the project that has been pulled. In other implementations (e.g., a git-based system), a PR may pull a commit from an external source (e.g., a local or remote repository). A PR may include a description and a purpose of the code change, and the code change of the PR may be merged into the original project with a commit transaction, as described next.

A commit, which usually corresponds to a PR, is a task to record (or “check-in”) an the updated pulled test code and the source code change, that is, a commit is a task that saves a changed file and changed content, generally, into a code repository or the like. The SCCS or the like may implement a commit by recording the code change so that a history of the code may be tracked and the code may be reverted to a previous version when necessary, and also by unlocking the relevant part of the project (e.g., a file, module, code block, etc.) to allow it to be pulled (checked out) by other users.

When a commit is identified at operation 110, it may be assumed that there is a failure associated with the commit. For example, the commit may be intended to correct a previously identified failure.

In operation 120, the electronic device 500 may determine whether the commit detected in operation 110 is a type that may be categorized as a potential failure benchmark component (e.g., has potential to be used for training a LLM), which may be performed based on predetermined criteria. A failure benchmark component may be an element that may be used during software development to evaluate a specific code change or performance and a quality failure detection ability of the commit with respect to the project. A potential failure benchmark component is a component that has potential (i.e., is a candidate) to serve as a failure benchmark component (e.g., one that has passed an initial filter as per operation 120).

The predetermined criteria may include, as non-limiting examples, a first criterion for determining whether the failure exists in source code, a second criterion for determining whether the failure is reproducible, and/or a third criterion for determining whether the failure is independent. The criteria may include a condition that the code being committed is known to have at least one failure, e.g., from a test case. As noted below, the second criterion may require that, among all collected failures, at least one test must fail in the buggy version and must not fail after the commit. This indicates that the commit is indeed addressing at least one known failure (e.g., from a test case) that existed prior to the code change.

The first criterion may be for determining whether a failure corresponding to the commit is related to a functional error in a software system of the project (here, “function” refers to a function of the software system as used/compiled, i.e., something that the software system does when being used). For example, a PR/commit that does not meet the first criterion may be one that includes only changes to a build script, documentation, or test code.

The second criterion may be a criterion that requires that, for all failures collected, at least one test should fail in a buggy version and a test should not fail after the commit.

The third criterion may be for determining whether a code change of the commit includes content for fixing a failure and does not include an implementation of an additional feature. For example, the third criterion may be for determining whether the code change of the commit extends the source code of the project or whether it updates existing source code.

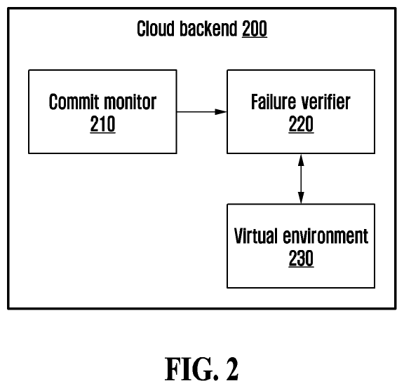

In operation 130, the electronic device 500 may verify in a virtual environment (e.g., a virtual environment 230 of FIG. 2) whether the commit has fixed an actual failure. The electronic device 500 may determine whether a new test fails before applying the commit and succeeds after applying the commit in the virtual environment. To elaborate on operation 130 and its relation to the second criterion, consider that the second criterion may establish the conceptual requirement that a known failure, which manifests as a failing test before the commit, should no longer fail after the commit has been applied. In other words, the second criterion defines the standard that must be met—i.e., previously failing tests must now pass. In contrast, operation 130 involves how this criterion is actually verified in practice, that is, how the electronic device (e.g., device 500) executes tests in a virtual environment both before and after the commit. By doing so, the device can confirm whether the commit resolves the known failure as required by the second criterion. In short, the second criterion sets out the condition that must be met (the “what”), while operation 130 details the procedural steps to assess and confirm that condition (the “how”).

Furthermore, regarding the “new test” mentioned directly above, this “new test” does not refer to a completely new or different test case. Rather, it signifies the re-execution of an existing test or test scenario in the changed environment—i.e., before and after the commit. By running the same (previously known) test again, the system can determine whether the outcome has changed from failure (pre-commit) to success (post-commit). Thus, the term “new test” may also be considered to be a “new execution” or a “new run” of the existing test, rather than the introduction of a novel test case.

The virtual environment may be a container generated, for example, based on Docker or may be a virtual machine (VM). Docker is container-based virtualization technology (in contrast to system-level virtualization); software within a container to provide a consistent isolated execution environment. Use of a Docker container may help increase reproducibility of a test by minimizing a difference between a development environment and an actual operating environment (e.g., testing may be done in a duplicate of the actual operating environment). Alternatively, the virtual environment may be a system-level VM (full system virtualization) that provides virtualization at the hardware level, with the VM (e.g., guest operating system and the like) configured to provide an independent execution environment that mirrors the actual operating environment. A VM may allow different operating systems and software to run simultaneously, supporting a variety of test scenarios. In another implementation, the virtual environment may be provided as part of a development environment.

As noted, the electronic device 500 may perform a commit verification in the virtual environment. Specifically, first, a new test may be executed in the virtual environment in a pre-commit state of the project to determine whether the new test fails. Assuming that the electronic device 500 confirms that a failure exists in the current/pre-commit code, then second, the electronic device 500 may re-execute the same test on the project after applying the commit to the project and determine whether the test succeeds. When the post-commit test succeeds, it may be determined that the commit has successfully fixed the failure. The electronic device 500 may perform these processes repeatedly and to verify the validity of the commit.

Regarding the verification process mentioned directly above, the verification process does not solely rely on prior test data logged in the past. Instead, it may involve re-running the test in a virtual environment both before and after the commit is applied. This allows the system to generate fresh, current test results to confirm whether the previously observed failure is now resolved. In other words, rather than depending only on historical data, the approach actively re-tests under the same conditions (pre-commit code vs. post-commit code) to empirically validate that the commit corrects the known failure.

Running the same known-failure test multiple times before and after the commit to ensure consistency and confirm that the previously identified failure is reliably resolved. Some test scenarios as now described.

Different Failures or Test Data: Repeating operations 110 through 130 for different known failures or different sets of test data. with this technique, the system can verify not just one fixed failure, but systematically address multiple failures, potentially reducing them from, for example, 10 down to 5, then to 3, and so forth, over multiple iterative cycles of modification and verification.

Incremental Improvements Prior to a Single Commit: A user/developer might not commit every small change immediately. Instead, they might perform a series of modifications and debugging steps before finalizing a commit. By understanding and tracking these incremental improvements, the system can run through operations 110-130 multiple times at various intermediate stages, each time confirming that certain failures have been fixed. Ultimately, a final commit might resolve a substantial number of failures all at once, or reflect incremental fixes made over several rounds of testing.

As may be seen, the concept of a “commit” can be somewhat flexible as used herein. The verification processes can be invoked repeatedly as the user makes incremental improvements, ensuring that multiple failures are addressed and progressively diminished before finalizing a stable commit.

Thus, the electronic device 500 may verify, utilizing the virtual environment, whether the commit has fixed the failure. When the electronic device 500 verifies that the commit has fixed the failure, it may be determined that the PR created in the project has fixed the actual failure.

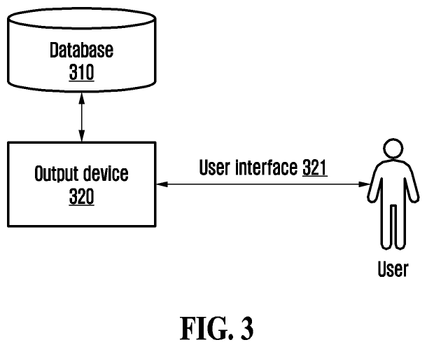

When the commit the failure-fix of the commit is verified by operation 130, then in operation 140, the electronic device 500 may store a failure PR corresponding to the commit in a database (e.g., a database 310 of FIG. 3).

The database may include metadata on the failure detection test and failure fix commit, bug-revealing test data, and/or patch information data. The database may be used, among other things, to train an LLM for code development tasks such as predicting a code change to correct a bug.

The metadata may include a time the PR was created, an ID of a bug report (or an ID of the PR), and a uniform/universal resource locator (URL) of the bug report, as non-limiting examples. That is, the metadata may include a time the test was performed, an environment in which the test was performed, a commit ID fixed file (file that has been fixed), code change content, or the like.

The bug-revealing test data may include a list of one or more tests that reveal a bug, and the tests may fail in the buggy version and pass in a fixed version. For each test, an absolute path and a root cause may be confirmed. The bug-revealing test data may include a test case that has actually detected a failure and may be used to reproduce and verify the failure.

Patch information may include patch information collected, for example, using git diff between the buggy version and the fixed version. git diff is a command in Git that compares and displays a difference between files. When receiving the git diff command, the electronic device 500 may display source code change content between a current file and a previous version of the file. In sum, patch information data may record the code change required to fix a failure and may include details of fixed code.

The electronic device 500 may classify and store a failure type according to a type of the failure that has been fixed by the corresponding PR.

When a failure PR is created, the electronic device 500 may analyze the type of failure that the PR has fixed. Failure types may be classified by various criteria. For example, the criteria may include a logic error in the code, a performance error, or the like. Thus, the failure types may be classified differently depending on a cause of the failure and a method of fixing the failure.

The electronic device 500 may use various code analysis tools to analyze the fixed code in the failure PR to automatically determine what type of failure has been fixed. For example, when analysis indicates that the logic of a specific function has changed, this may be classified as a logical error. When analysis indicates that a correction is included that optimizes a memory usage, an operating time, or the like by changing a method of applying the specific function, this may be classified as a performance error.

The electronic device 500 may store failure data according to the failure type. Thus, information stored in the database may include the failure type, fixed code, the bug-revealing test data, metadata, and the like.

The electronic device 500 may receive a user input through a user interface (e.g., a user interface 321 of FIG. 3) and may provide information related to a failure corresponding to the user input using the failure data stored in the database.

The user interface may include a command-line interface (CLI)-based frontend that receives an information inquiry command, a failure inquiry command, a compile command, or a test execution command from the user and provides functions corresponding to the commands.

The CLI-based frontend may provide a function corresponding to an auto-update execution command that allows the user to update a failure benchmark.

The user may interact with the benchmark system by entering various commands via the CLI. For example, when the user wants to look up information on a specific failure, the user may enter an “info” command, which is the information inquiry command, in the CLI to search for the failure data stored in the database. The benchmark system may provide the user with detailed information of the failure, fix content of the failure, associated test data, or the like.

In addition, the user may view a version of the code that includes a specific failure by entering a “checkout” command, which is the failure inquiry command, in the CLI. When receiving the “checkout” command, the benchmark system may provide code of a time the failure occurred and code of a time after the code was fixed to be compared with each other through an interface, and the user may review and understand the code change.

The “compile” command may compile a specific version of code so that it may be confirmed whether changed code builds properly.

The “test” command may perform a test by executing the compiled code, and a test result may be used to verify whether the failure has been fixed.

The CLI-based frontend may provide the auto-update execution command, allowing the user to keep the failure benchmark up to date. When the user enters the “update” command, the benchmark system may automatically download new failure data and update the existing database. Through this, the electronic device 500 may continuously maintain a benchmark that reflects latest failure information.

FIG. 2 illustrates an example of a cloud backend of a benchmark system, according to one or more embodiments.

The description provided with reference to FIG. 1 is generally applicable to FIG. 2.

One or more blocks shown in FIG. 2 or a combination thereof may be implemented by a special-purpose hardware-based computer that performs a predetermined function or a combination of computer instructions and special-purpose hardware. Next, a cloud backend 200 of the software debugging benchmark system 400 built into the electronic device 500 is described in detail.

Referring to FIG. 2, the benchmark system (e.g., the software debugging benchmark system 400 of FIG. 4) may include the cloud backend 200. In the benchmark system, the cloud backend 200 may play a central role in an entire system and may connect to and manage other components. The cloud backend 200 may include a commit monitor 210 and a failure verifier 220.

The commit monitor 210 may continuously monitor source code of a project to detect a new commit. The commit monitor 210 may detect whenever a new commit occurs and transfer the new commit to the failure verifier 220. The commit monitor 210 may periodically confirm a state of the source code of the project and track a commit whenever the commit occurs. Through this process, content of the commit may be analyzed and it may be confirmed whether the corresponding commit includes a potential failure.

The failure verifier 220 may analyze the commit received from the commit monitor 210 to verify whether the commit has fixed an actual failure. The failure verifier 220 may perform, in the virtual environment 230, a new test (“new” in the sense of being newly performed) and confirm if the new test fails before applying the commit and succeeds after applying the commit. The failure verifier 220 may execute code that includes (is compiled with) the commit and determine whether a failure exists based on a result of the execution. The failure verifier 220 may test, using the virtual environment 230, whether the commit has actually fixed the failure or whether a new failure has occurred. In the virtual environment 230, a test may be automatically run, and a failure may be verified by comparing a code state before the commit with a code state after the commit.

The virtual environment 230 may support the commit verifier 220 and imitate an actual software execution environment. The virtual environment 230 may be generated using a method (or a device) such as Docker or a VM. The virtual environment 230 may provide an independent execution environment that may perform tests before and after the commit. The test in the virtual environment 230 may ensure test consistency and reproducibility during a failure verification process.

FIG. 3 illustrates an example of operation of a frontend of a benchmark system, according to one or more embodiments.

The description provided with reference to FIGS. 1 and 2 is generally applicable to FIG. 3.

The database 310 may be a data storage of a benchmark system and may store failure data, a test result, metadata, and the like. The data may be continuously updated through interaction with other components of the benchmark system. The database 310 may store information on a failure detection test and failure fix commit, and may transfer corresponding data to an output device 320 upon a user request.

The output device 320 may be a device displaying the user interface 321 and may include a terminal of a user that uses the benchmark system. The terminal may be a device that may install and run a server-related application and may provide the user interface 321 to the user. The user interface 321 may be provided by the terminal itself. For example, the user interface 321 may be provided by an operating system (OS) of the terminal or may be provided by an application installed on the terminal. In addition, the user interface 321 may be provided by the server, and the terminal may simply receive and display the user interface 321 provided by the server. The output device 320 may retrieve data received from the database 310 and display the data on the user interface 321 or may return appropriate data by processing a user input.

The user interface 321 may be the primary means by which the user may interact with the benchmark system. The user interface 321 may be displayed on the output device 320 and may be implemented as a CLI-based frontend through which the user may enter a command and check a result. The user interface 321 may receive an information inquiry command, a failure inquiry command, a compile command, a test execution command, and an auto-update execution command so that the benchmark system may provide functions corresponding to the commands.

The database 310 may provide the stored failure data and metadata to the output device 320. When the user looks up a specific failure (failure information) or requests a specific test result, the output device 320 may retrieve corresponding information from the database 310 and transmit the information to the user.

The output device 320 may process a command entered by the user and return a result to the user through the user interface 321. When the user enters a command through the CLI, the output device 320 may interpret the command and perform an appropriate operation.

For example, when the user enters a command to look up information on a specific failure, the output device 320 may retrieve corresponding information from the database 310 and display a result on the user interface 321. In addition, when the user enters the compile command or the test execution command, the output device 320 may perform corresponding tasks and return results.

FIG. 4 illustrates an example of overall operation of a benchmark system, according to one or more embodiments.

The description provided with reference to FIGS. 1 to 3 is generally applicable to FIG. 4

Referring to FIG. 4, the software debugging benchmark system 400 may be implemented through the commit 410, a continuous integration (CI) system 420 that may receive committed code, the cloud backend 200, the database 310, and the output device 320.

The commit 410 may be an operation in which a developer saves a change to source code. The change may include an addition of a new feature, a bug fix, code improvement, and the like. The change may be integrated into a central repository (or other code base), and possibly propagated to other copies of the code base.

The CI system 420 may be a system that automatically performs a build and test whenever a commit is performed, i.e., whenever a code change is merged into the central repository. The CI system 420 may receive committed code, automatically build the committed code, and run a predefined test to verify that the change works correctly (e.g., has no errors, fixes a previous error, reduces a number of errors, passes a particular test, etc.).

When a user invokes the commit 410 for a source code change, the CI system 420 may automatically detect the commit 410 and perform a corresponding build and test using the committed code. If the commit 410 is successfully built and tested in the CI system 420, the commit 410 may be transferred to the commit monitor 210. The commit monitor 210 may continuously monitor and analyze the commit 410. In short, the commit monitor 210 may function as a kind of shim to facilitate other functionality (e.g., benchmarking) associated with commits submitted to the CI system 420.

The commit monitor 210 may transfer the commit 410 to the failure verifier 220. The failure verifier 220 may verify in the virtual environment 230 whether the commit 410 has fixed an actual failure. The failure verifier 220 may determine whether a failure exists (prior to the commit 210) by performing, in the virtual environment 230, a test on the corresponding code in its state before the commit 210 and a test on the code with the commit 410 incorporated therein. A verification result of the testing may be stored in the database 310 in association with the commit 410.

Information on the verified commit 410 may also be stored in the database 310 in association with the commit 410, and the database 310 may manage information related to the failure. The database 310 may then provide the stored failure data upon request from the output device 320. The output device 320 may transfer the stored failure data to the user interface 321 or appropriately process and display the stored failure data according to a user request.

When a user enters a command through a CLI displayed by a device of the user, the output device 320 may process the command, retrieve necessary data from the database 310, and display the data on the user interface 321.

FIG. 5 illustrates a block diagram of an example of an electronic device, according to one or more embodiments

Referring to FIG. 5, an electronic device 500 may include a processor 530 (in practice one or more processors of any of variety of type(s) of processor(s)), a memory 550, and an output device 570 (e.g., a display). The processor 530, the memory 550, and the output device 570 may be connected to one another through a communication bus 505. The electronic device 500 may include, for an operation of the electronic device 500, the processor 530 for performing at least one of the methods described above or an algorithm corresponding to at least one of the methods.

The output device 570 may display the user interface 321 that receives, from the processor 530, a user input related to the software debugging benchmark system 400. The output device 570 may be a same device as the output device 320 of FIG. 3. However, the output device 570 may also be a different device (e.g., a client device) from the output device 320 of FIG. 3. In this case, the output device 570 may be built into the electronic device 500 to drive the software debugging benchmark system 400 or may be a terminal device of a user.

The memory 550 may store data related to an operation of the software debugging benchmark system 400, performed by the processor 530. Furthermore, the memory 550 may store a variety of information generated in a processing process of the processor 530 described above. In addition, the memory 550 may store a variety of data and programs. The memory 550 may include volatile memory or non-volatile memory. The memory 550 may include a large-capacity storage medium such as a hard disk to store a variety of data.

In addition, the processor 530 may perform at least one of the methods described with reference to FIGS. 1 to 4 or an algorithm corresponding to at least one of the methods. In the process described above, the processor 530 may be a data processing device implemented as hardware including a circuit having a physical structure to perform desired operations. The desired operations may include, for example, instructions or code in a program. The processor 530 may be implemented as, for example, a central processing unit (CPU), a graphics processing unit (GPU), or a neural network processing unit (NPU). For example, the electronic device 500 implemented as hardware may include, for example, a microprocessor, a CPU, a processor core, a multi-core processor, a multiprocessor, an application-specific integrated circuit (ASIC), and a field programmable gate array (FPGA).

The processor 530 may execute a program (in the form of instructions) and control the electronic device 500. Program code to be executed by the processor 530 may be stored in the memory 550.

In some implementations, the cloud backend 200, the commit monitor 210, the failure verifier 220, and the virtual environment 230 may all be run or implemented by the processor 530.

The processor 530 may periodically monitor PRs created in a project, identify a commit in a PR that adds a source code change and test code, determine whether the commit is a potential failure benchmark component (i.e., a type of commit that is a potential failure benchmark) based on predetermined criteria, verify in a virtual environment whether the commit has fixed an actual failure, and when the commit is verified as a failure detection test (pre-commit) and failure fix commit (post-commit) as a result of the verification, and store a failure PR corresponding to the commit in the database. The test code is explained next.

Test code serves as executable verification code that can be compiled and run alongside production code. It explicitly defines the expected behavior (outputs and results) under certain conditions (input data and environment settings), allowing a clear determination as to whether the code operates as intended or contains defects.

Test code described herein is used to perform the same tests before and after a commit (code change) is applied. If a certain test case fails when executed in the pre-commit state, it indicates the presence of a defect in the codebase. Then, if the same test code is run again in the post-commit state and the previously failing test case no longer fails, this empirically demonstrates that the commit in question is a “valid patch” that genuinely fixes the defect.

Test code is not limited to a single execution; it can be run repeatedly as needed. This enables continuous verification of various potential defects and the tracking of how the defect count decreases over time by repeatedly comparing the pre- and post-commit states. For example, if the initial codebase has 10 defects, these can be verified with test code. As modifications and debugging proceed, the number of defects may gradually reduce to 5, then 3, and test code can be reused at each stage to confirm these improvements in real time.

To fairly evaluate Large Language Model (LLM)-based automated debugging technologies, a benchmark containing new defect cases that the model has not previously learned is highly beneficial. By automatically selecting recent, PR-based defects from open-source projects and extracting only those reproducible via test code, a defect benchmark with high realism and minimal data leakage may be constructed. This overcomes the update delays and quality degradation issues associated with manually collected or refined benchmarks, ensuring that LLM-based technologies can be tested under more comparable conditions.

Defect data collected and verified through test code can be leveraged for various analysis and improvement tasks. For instance, delta debugging or patch pattern analysis can be employed to automatically classify defects by type or gauge the difficulty of certain fixes. This not only benefits automated debugging technologies but also contributes to enhancing software quality and refining the development process.

In sum, the “test code” described in this invention is a key verification tool for proving the quality of code changes and determining the presence and resolution of defects. By moving beyond the mere aggregation of defects and patches to automatically generating and updating a benchmark equipped with an operational verification environment, it may be possible to provide the fairness, reliability, and scalability that effectively evaluate LLM-based automated debugging technologies.

The examples described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media (not a signal per se) including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The computing apparatuses, the electronic devices, the processors, the memories, the image sensors, the displays, the information output system and hardware, the storage devices, and other apparatuses, devices, units, modules, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An operating method of a software debugging benchmark system, the operating method comprising:
monitoring pull requests (PRs) created in a project and identifying, in a PR identified by the monitoring, a commit that adds a source code change and test code;
determining whether the commit is a potential failure benchmark component by applying predetermined criteria to the commit;
based on determining that the commit is a potential failure benchmark component, verifying, in a virtual environment, whether the commit has fixed an actual failure; and
based on the verifying, storing a failure PR corresponding to the commit in a database as a failure detection test and failure fix commit.

2. The operating method of claim 1, further comprising:
receiving a user input through a user interface and providing information related to a failure corresponding to the user input using failure data stored in the database.

3. The operating method of claim 1, wherein the predetermined criteria comprises:
a first criterion for determining whether the actual failure exists in source code, a second criterion for determining whether the actual failure is reproducible, and/or a third criterion for determining whether the actual failure is independent.

4. The operating method of claim 1, wherein the verifying of whether the commit has fixed the actual failure comprises:
determining whether, in the virtual environment, a test performed on the project in a state before applying the commit fails and whether the a test performed on the project after applying the commit succeeds.

5. The operating method of claim 1, wherein the database comprises:
metadata on tests on the pre-commit project and the post-commit project, bug-revealing test data used for the tests, and/or patch information data.

6. The operating method of claim 2, wherein the user interface comprises:
a command-line interface (CLI)-based frontend that receives an information inquiry command, a failure inquiry command, a compile command, or a test execution command from a user input device and provides functions corresponding to the information inquiry command, the failure inquiry command, a compile command, or the test execution command.

7. The operating method of claim 6, wherein the CLI-based frontend is configured to provide a function corresponding to an auto-update execution command that allows the user to update a failure benchmark.

8. The operating method of claim 1, wherein the virtual environment comprises a Docker container or a virtual machine.

9. The operating method of claim 1, wherein the storing of the failure PR in the database comprises:
classifying and storing a failure type according to a type of the failure PR that has been fixed by the commit.

10. A non-transitory computer-readable storage medium storing instructions that, when executed by a processor, cause the processor to perform the method of claim 1.

11. An electronic device comprising:
a memory configured to store instructions; and
one or more processors,
wherein the instructions, when executed by the one or more processors, cause the electronic device to:
monitor pull requests (PRs) created in a project and identify, in a PR identified by the monitoring, a commit that adds a source code change and test code;
determine whether the commit is a potential failure benchmark component by applying predetermined criteria to the criteria;
based on determining that the commit is a potential failure benchmark component, verify, in a virtual environment, whether the commit has fixed an actual failure; and
based on the verifying, store a failure PR corresponding to the commit in a database as a failure detection test and failure fix commit.

12. The electronic device of claim 11, wherein the instructions, when executed by the one or more processors, cause the electronic device to:
receive a user input through a user interface and provide information related to a failure corresponding to the user input using failure data stored in the database.

13. The electronic device of claim 11, wherein the predetermined criteria comprises:
a first criterion for determining whether an actual failure exists in source code, a second criterion for determining whether the actual failure is reproducible, and/or a third criterion for determining whether the actual failure is independent.

14. The electronic device of claim 11, wherein the instructions, when executed by the one or more processors, cause the electronic device to:
determine whether, in the virtual environment, a test performed on the project in a state before applying the commit fails and whether a test performed on the project after applying the commit succeeds.

15. The electronic device of claim 11, wherein the database comprises:
metadata on the test on the pre-commit project and post-commit project, bug-revealing test data used for the tests, and/or patch information data.

16. The electronic device of claim 12, wherein the user interface comprises:
a command-line interface (CLI)-based frontend that receives at least one of an information inquiry command, a failure inquiry command, a compile command, or a test execution command from a user input device and provides functions corresponding to the information inquiry command, the failure inquiry command, a compile command, or the test execution command.

17. The electronic device of claim 16, wherein the CLI-based frontend is configured to provide a function corresponding to an auto-update execution command that allows the user to update a failure benchmark.

18. The electronic device of claim 11, wherein the virtual environment comprises a Docker container or a virtual machine.

19. The electronic device of claim 11, wherein the instructions, when executed by the one or more processors, cause the electronic device to:
classify and store a failure type according to a type of the failure PR that has been fixed by the commit.

20. A method of collecting code commits, the method comprising:
detecting commits of source code to a project;
selecting, from among the detected commits, candidate commits that are determined to be suitable for failure benchmarking;
for each of the candidate commits, performing a corresponding pre-commit test of the project and a corresponding post-commit test of the project;
collecting those of the candidate commits whose pre-commit test produces a failure of the pre-commit project and whose corresponding post-commit test does not have the corresponding failure; and
training a large language model based on the collected candidate commits.
